(19) United States
(12) Patent Application Publication
(10) Pub. No.: US 2004/0081451 A1
(43) Pub. Date: Apr. 29, 2004

(54) Driver and light quantity adjusting device

(76) Inventor: Yoshio Takada, Chiba (JP)

Correspondence Address: ROBIN BLECKER & DALEY, 2ND FLOOR, 330 MADISON AVENUE, NEW YORK, NY, 10017, US

(21) Appl. No.: 10/687,461

(22) Filed: Oct. 16, 2003

(30) Foreign Application Priority Data
Oct. 21, 2002 (JP) 2002-305409

(51) Int. Cl. G03B 9/02

(52) U.S. Cl. 396/508

(57) ABSTRACT

Disclosed is a device for adjusting a quantity of light, including a rotor adapted to be rotated with an axis portion as a center, a first bearing for supporting one end of the axis portion of the rotor, a second bearing for supporting the other end of the axis portion of the rotor, and a member for adjusting a quantity of light which moves in accordance with a rotation of the rotor. According to this construction, a portion of the first bearing into which the axis portion is fitted has a tapered shape, and the axis portion is brought into contact with the portion having the tapered shape of the first bearing, whereby the accuracy of determining a position at which the rotor stops is improved.

### BACKGROUND OF THE INVENTION

1. Field of the Invention

The present invention relates to improvements of a device for adjusting a quantity of light which is provided to an image pickup device such as a video camera, a still camera for a silver salt film, or a digital still camera, and of a driver used in the device for adjusting a quantity of light.

2. Related Background Art

FIGS. 6A and 6B are respectively cross sectional views each showing a driver used in a conventional device for adjusting a quantity of light as disclosed in U.S. Pat. No. 6,027,261, for example. A construction of the driver will hereinbelow be described.

In FIGS. 6A and 6B, reference numeral 101 designates a first case that has a (cylindrical) first bearing portion 101a having a U-like shape in cross section at its center. Reference numeral 102 designates a driving lever which has an axis portion 102c, and pins 102i and 102h adapted to operate members for adjusting a quantity of light such as a diaphragm blade and a shutter blade. A semi-spherical (spherical) shaped front end portion 102a which is inserted into the bearing portion 101a is provided in one end of the axis portion 102c. A rear end portion 102b which is inserted into a second bearing portion 104a formed in a second case 104 as will be described later is provided in the other end of the axis portion 102c. The axis portion 102c of the driving lever 102 is formed so as for its diameter to be larger than that of each of the front end portion 102a and the rear end portion 102b. Then, a rotor magnet 103 is fixed to the axis portion 102c.

Reference numeral 104 designates the second case. The first case 101 is fitted into the second case 104 to form a bobbin. A coil (not shown in FIGS. 6A and 6B) is wound around the outer periphery of the bobbin including the first case 101 and the second case 104. The second bearing portion 104a into which the rear end portion 102b of the driving lever 102, as described above, is inserted is formed at a center of the second case 104. The bobbin is provided with a yoke 105 having a magnetic shielding function as well. Reference numeral 118 designates a Hall element for detecting a rotation position of the rotor magnet 103.

FIG. 6A is an enlarged cross sectional view of the bearing portion 101a of the first case 101. As shown in FIG. 6A, a bottom surface (abutment portion) of the first bearing portion 101a is planar.

The yoke 105 is arranged in a position slightly shifted in a thrust direction with respect to the rotor magnet 103, whereby the rotor magnet 103 receives a magnetic attraction force in a direction indicated by an arrow r. As a result, the front end portion 102a provided in the axis portion 102c point-contacts the bottom surface of the bearing portion 101a to regulate the position of the driving lever in the thrust direction. In addition, at this time, a gap is defined between the rear end portion 102b and the bottom surface of the second bearing portion 104a. With this construction, a backlash of the driving lever 102 in the thrust direction can be eliminated while a contact area of the driving lever 102 in the thrust direction can be reduced. Hence, it is possible to reduce an operating load of the driver.

With the above-mentioned construction, if a current is caused to flow through a coil wound around the bobbin including the first case 101 and the second case 104, then a magnetic force is generated between the coil and the rotor magnet 103 so that the rotor magnet 103 performs rotation. The driving pins 102i and 102h of the driving lever 102 fixed to the rotor magnet 103 are rotated to thereby drive the members for adjusting a quantity of light such as a diaphragm blade and a shutter blade into which the driving pins 102i and 102h are fitted.

FIG. 7 is a cross sectional view of a driver used in another conventional device for adjusting a quantity of light as disclosed in Japanese Patent Application Laid-Open No. H7-281252 for example.

In the figure, reference numeral 201 designates a bobbin as a supporting member for a coil, reference numeral 202 designates an axis of rotation, reference numeral 203 designates a rotor magnet fixed to the rotation axis 202, reference numeral 204 designates a bearing member having a first bearing portion 204a, and reference numeral 205 designates a supporting member which is provided for the whole device for adjusting a quantity of light and which includes a second bearing portion 205a.

The rotor magnet 203 is fixed to nearly a central portion of the rotation axis 202. Radially projecting portions 202a and 202b each having a diameter larger than that of a peripheral axis portion are formed in positions remote from the rotor magnet 203, respectively. The radially projecting portion 202a is arranged within the first bearing portion 204a, and the radially projecting portion 202b is arranged within the second bearing portion 205b. Unlike the construction shown in FIGS. 6A and 6B, with this bearing construction, a plane formed in the radially projecting portion 202a or 202b contacts a plane formed in a bottom surface of the bearing portion 201a or 201b. In this example as well, the rotation axis 202 is biased to one side of the thrust direction in accordance with the same method as that in FIGS. 6A and 6B.

With the above-mentioned construction, if a current is caused to flow through a coil wound around the bobbin 201, then a magnetic force is generated between the coil and the rotor magnet 203 so that the rotor magnet 203 performs rotation and the rotation axis 202 fixed to the rotor magnet 203 is also rotated. A driving lever (not shown) is fixed to the front end on the radially projecting portion 202b side of the rotation axis 202 by press-fitting, bonding or the like. Consequently, the driving lever is rotated along with the rotation of the rotation axis 202, whereby similarly to the case shown in FIGS. 6A and 6B, it is possible to operate the members for adjusting a quantity of light.

In the above-mentioned conventional constructions shown in FIGS. 6A and 6B, and FIG. 7, since the driving lever 102 and the rotation axis 202 are supported by the bearing portions, respectively, the radial movement is regulated. However, strictly speaking, small gaps are defined between the driving lever 102 and the rotation axis 202, and the bearing portions, respectively, so that the driving lever 102 and the rotation axis 202 can be smoothly rotated.

Since the rotor magnet has been miniaturized along with miniaturization and lightening of the device for adjusting a quantity of light, a load applied to the device for adjusting a quantity of light has been reduced. The axis of rotation to which the rotor magnet is fixed is biased in one direction of radial direction in a static state. However, if the rotor magnet is rotated, then a direction in which the force is applied to the rotor magnet is changed along with this rotation, and as a result, a direction in which the axis of rotation is biased is changed accordingly. The position of the axis of rotation in a radial direction is changed within the bearing portion even due to a disturbance such as a vibration or a mechanical shock. That is to say, since the position of the axis of rotation in the radial direction within the bearing portion is changed, the rotor magnet may not be smoothly rotated in some cases. Thus, there is a possibility that the proper operation of the members for adjusting a quantity of light is impeded due to that influence, and a quantity of light is not properly adjusted.

In particular, in a case where the rotation position of the driver used in the device for adjusting a quantity of light is controlled in accordance with an output signal from the Hall element, if a distance between the Hall element and the rotor magnet is changed, then the rotation position is regarded as being changed, and thus the members for adjusting a quantity of light are excessively moved in some cases.

Consequently, when a device for adjusting a quantity of light of this sort is provided to a digital camera, for example, there is a possibility that a fluctuation of the members for adjusting a quantity of light due to a fine fluctuation of a driver may exert an influence on a resultant image due to miniaturization of an optical system.

### SUMMARY OF THE INVENTION

According to the present invention, there is provided a driver, including:

a rotor adapted to be rotated with an axis portion as a center;

a first bearing for supporting one end of the axis portion of the rotor; and

a second bearing for supporting the other end of the axis portion of the rotor,

in which a portion of the first bearing into which the axis portion is fitted has a tapered shape, and the axis portion is brought into contact with the portion having the tapered shape of the first bearing.

Further, according to the present invention, there is provided a driver, including:

a rotor adapted to be rotated with an axis portion as a center;

a first bearing for supporting one end of the axis portion of the rotor; and

a second bearing for supporting the other end of the axis portion of the rotor,

in which a portion of the axis portion which is fitted into the first bearing has a tapered shape, and the first bearing is brought into contact with the portion having the tapered shape of the axis portion.

Further, according to the present invention, there is provided a device for adjusting a quantity of light, including:

a rotor adapted to be rotated with an axis portion as a center;

a first bearing for supporting one end of the axis portion of the rotor;

a second bearing for supporting the other end of the axis portion of the rotor; and

a member for adjusting a quantity of light which moves in accordance with a rotation of the rotor,

in which a portion of the first bearing into which the axis portion is fitted has a tapered shape, and the axis portion is brought into contact with the portion having the tapered shape of the first bearing.

Further, according to the present invention, there is provided a device for adjusting a quantity of light, including:

a rotor adapted to be rotated with an axis portion as a center;

a first bearing for supporting one end of the axis portion of the rotor;

a second bearing for supporting the other end of the axis portion of the rotor; and

a member for adjusting a quantity of light which moves in accordance with a rotation of the rotor,

in which a portion of the axis portion which is fitted into the first bearing has a tapered shape, and the first bearing is brought into contact with the portion having the tapered shape of the axis portion.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIGS. 1A and 1B are respectively cross sectional views of a driver used in a device for adjusting a quantity of light according to a first embodiment of the present invention;

FIGS. 2A and 2B are respectively exploded perspective views of the device for adjusting a quantity of light according to a first embodiment of the present invention;

FIGS. 3A, 3B, 3C and 3D are respectively constructional views of the device for adjusting a quantity of light according to the first embodiment of the present invention;

FIG. 4 is a cross sectional view showing a driver used in a device for adjusting a quantity of light according to a second embodiment of the present invention;

FIG. 5 is a cross sectional view showing a driver used in a device for adjusting a quantity of light according to a third embodiment of the present invention;

FIGS. 6A and 6B are respectively cross sectional views of an example of a driver used in a conventional device for adjusting a quantity of light;

FIG. 7 is a cross sectional view of another example of a driver used in a conventional device for adjusting a quantity of light; and

FIGS. 8A, 8B and 8C are respectively views for explaining effects of a construction of the driver according to the first embodiment of the present invention.

### DESCRIPTION OF THE PREFERRED EMBODIMENTS

Preferred embodiments of the present invention will hereinafter be described in detail with reference to the accompanying drawings.

First of all, a first embodiment will be described.

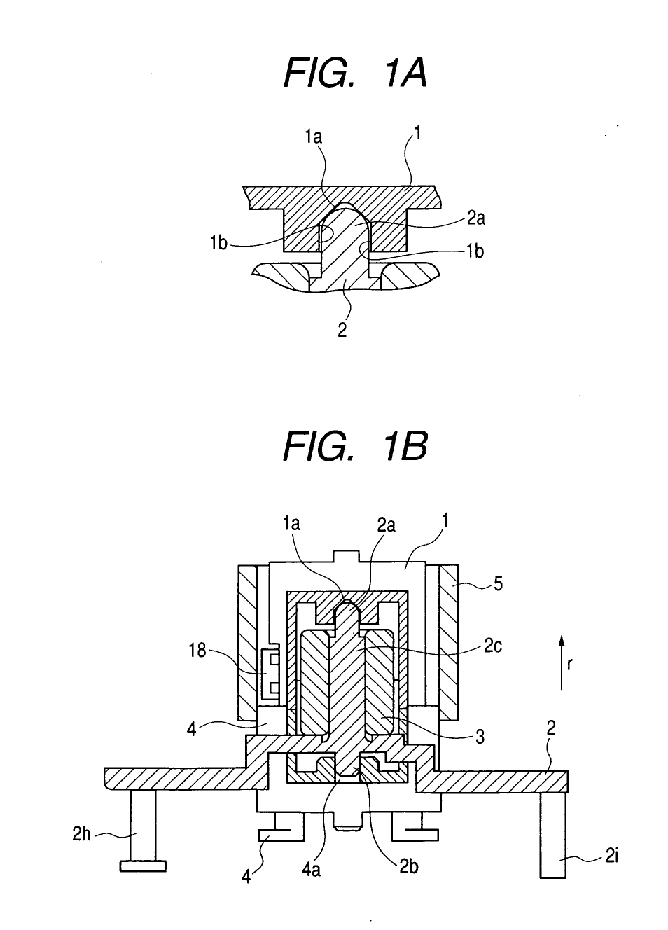

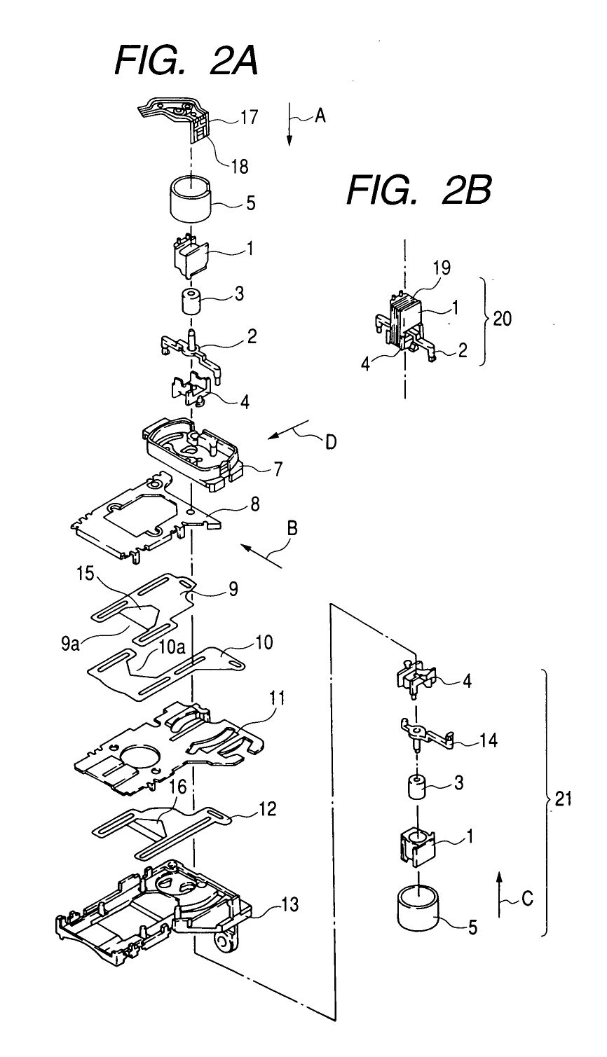

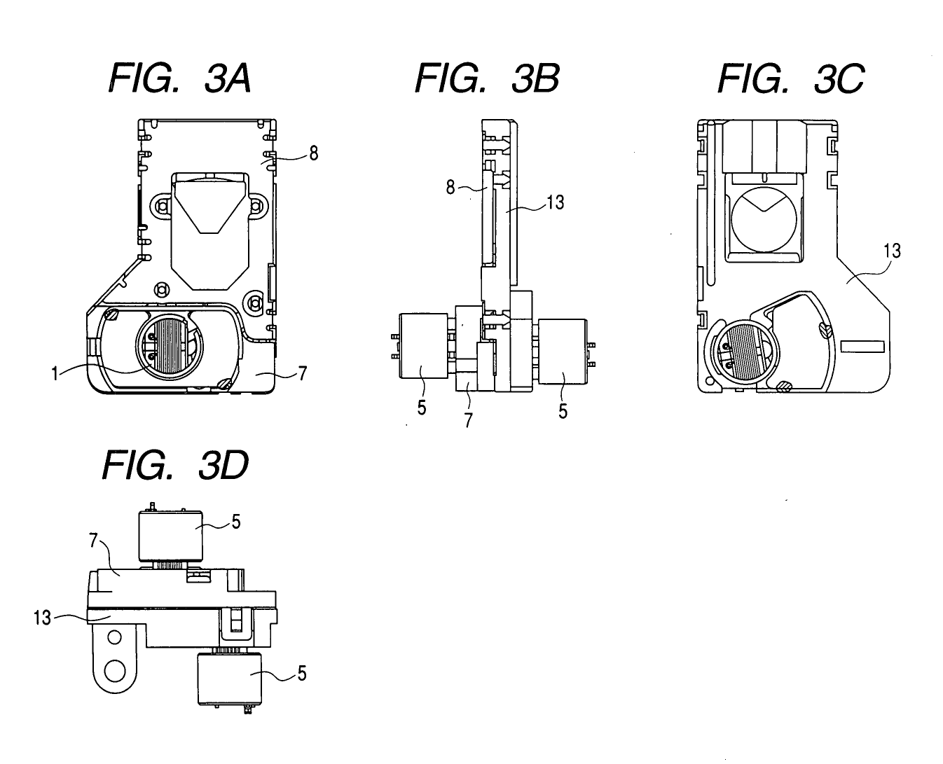

FIGS. 1A and 1B, FIGS. 2A and 2B and FIGS. 3A to 3D are respectively views each showing a device for adjusting a quantity of light according to the first embodiment of the present invention. More specifically, FIGS. 1A and 1B are respectively cross sectional views of a driver used in the device for adjusting a quantity of light, and FIGS. 2A and 2B are respectively exploded perspective views of the device for adjusting a quantity of light including the driver shown in FIGS. 1A and 1B. In addition, FIGS. 3A to 3D are respectively views each showing a state after completion of assembling of the device for adjusting a quantity of light shown in FIGS. 2A and 2B. FIG. 3A is a view when viewed from a direction indicated by an arrow A in FIG. 2A, FIG. 3B is a view when viewed from a direction indicated by an arrow B in FIG. 2A, FIG. 3C is a view when viewed from a direction indicated by an arrow C in FIG. 2A, and FIG. 3D is a view when viewed from a direction indicated by an arrow D in FIG. 2A.

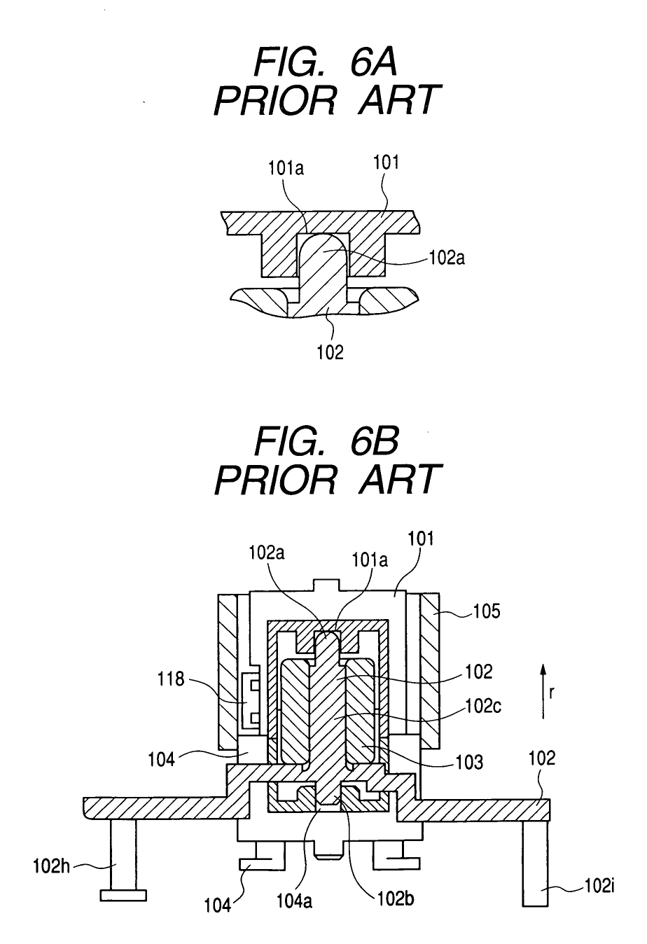

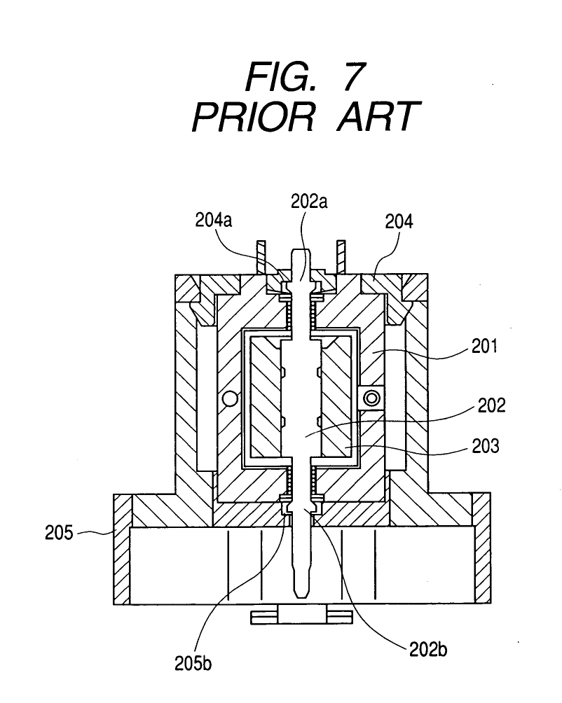

Note that, constituent elements designated by reference numerals 2, 2a, 2b, 3, 4, 4a, 5, and 18 in FIGS. 1A and 1B, FIGS. 2A and 2B and FIGS. 3A to 3D are the same as those designated by reference numerals 102, 102a, 102b, 103, 104, 104a, 105 and 118 in FIGS. 6A and 6B, respectively. In those figures, only a first case 1 shown in FIGS. 1A and 1B, FIGS. 2A and 2B and FIGS. 3A to 3D has a shape different from that of the first case 101 shown in FIGS. 6A and 6B.

In FIGS. 1A and 1B, FIGS. 2A and 2B and FIGS. 3A to 3D, a rotor magnet 3 is fixed to a driving lever 2 by bonding or press-fitting, and the driving lever 2 and the rotor magnet 3 are accommodated in a bobbin including the first case 1 and a second case 4. A bearing portion 1a and a bearing portion 4a are provided in the first case 1 and the second case 4, respectively. Then, a front end portion 2a and a rear end portion 2b which are formed at end portions of an axis portion 2c of the driving lever 2 are inserted into those bearing portions 1a and 4a, respectively. A coil 19 is wound around an outer periphery of a bobbin (the coil is wound around the outer periphery of the bobbin to thereby fix the first case 1 and the second case 4). A current is caused to flow through the coil, whereby a torque is generated in the rotor magnet 3. Note that, FIG. 2B is a perspective view of the driver 20.

In the driver used in the device for adjusting a quantity of light according to this embodiment, as described above, the first case 1 is different in construction from that of the driver shown in FIGS. 6A and 6B. As shown in FIG. 1A, the first bearing portion 1a provided in the first case 1 has a recess portion having a portion of a cylindrical shape and a portion of a conical shape (tapered shape) formed on the heels of the portion of the cylindrical shape. Note that, an angle of a vertex of the cone is desirably in the range of 90 to 110 degrees. This reason is that if the angle is increased, the first bearing portion 1a receives the first end portion 2a of the axis portion 2c almost on its planar portion, while if the angle is decreased, then a frictional area of the first bearing portion 1a against the front end portion 2a of the axis portion 2c is increased so that a thickness of the bearing portion 1a needs to be increased. The front end portion 2a of the axis portion 2c of the driving lever 2 has a semi-spherical (or spherical) shape. Then, the front end portion 2a line-contacts a slant face portion of the cone of the first bearing portion 1a. This contact state is viewed in the form of a circle when viewed from a thrust direction.

In addition, a cylindrical shaped portion 1b of the first bearing portion 1a has such a diameter as to be able to define a gap between and a side face of the front end portion 2a. Thus, the gap is adapted not to be closed even if a change in size occurs due to an influence of a temperature or the like. In addition, the axis portion 2c is prevented from falling by the cylindrical shaped portion 1b.

The rotor magnet 3 and the yoke 5 are arranged so that a central position between the rotor magnet 3 and the yoke 5 is shifted in a thrust direction, whereby the rotor magnet 3 receives a magnetic force with which it is biased. In this embodiment, as shown in FIG. 1B, a central position of the yoke 5 in the thrust direction is fixed to the upper side with respect to the central position of the rotor magnet 3 in the thrust direction, whereby the rotor magnet 3 is attracted to the upper side (in a direction indicated by an arrow r). As a result, the front end portion 2a is brought into contact with a conical shaped portion of the bearing portion 1a.

The second bearing portion 4a has a recess portion of a cylindrical shape. Since the axis portion 2a is biased to the bearing portion 1a side, the second bearing portion 4a is provided with no conical shaped portion with which the axis portion 2c is adapted to be brought into contact in the thrust direction. But, when the device for adjusting a quantity of light undergoes a disturbance such as a vibration, there is a possibility that the axis portion 2c may be brought into contact with a bottom surface of the second bearing portion 4a.

In this embodiment, there is adopted a construction such that the axis portion 2c is biased to the side of the first bearing portion 1a. However, there may be adopted a construction such that the axis portion 2c is biased to the side of the second bearing portion 4a. But, in this case, it is necessary that a conical shaped recess portion is formed in the second bearing portion 4a, and also an end face of the rear end portion 2b of the driving lever 2 is formed in semi-spherical (or spherical) shape.

If a current is caused to flow through a coil 19 of the driver after being assembled, then a magnetic field is generated around the coil 19. Then, the rotor magnet 3 and the driving lever 2 are rotated with the axis portion 2c of the driving lever 2 as an axis by an action of the magnetic field generated around the coil 19 and an action of the magnetic field of the rotor magnet 3. This torque is transmitted to members 9 and 10 for adjusting a quantity of light as members for adjusting a quantity of light shown in FIG. 2A through pins 2i and 2h to move the members 9 and 10 for adjusting a quantity of light.

Reference numeral 18 designates a magnetic sensor for detecting a position and an angular velocity of the rotor magnet 3. In this embodiment, a Hall element is used as the magnetic sensor 18. The Hall element 18 serves to detect a position and a velocity of the rotor magnet 3 on the basis of a change in voltage due to a change in distance between the Hall element 18 and the rotor magnet 3, or a change in magnetized position.

The driver 20 used in the device for adjusting a quantity of light according to the first embodiment, as shown in FIGS. 2A and 2B, is mounted to a driver supporting member 7. Note that, this device for adjusting a quantity of light includes the driver 20 for driving the members 9 and 10 for adjusting a quantity of light which serve to change a size of an opening portion by their movements, and a second driver 21 (a driver having constituent elements 4, 14, 3, 1, and 5 shown below in FIG. 2A) for driving an ND filter 16 which will be described later.

The driver supporting member 7 is fixed to a supporting member 13 of the device for adjusting a quantity of light. The second driver 21 for driving the ND filter (Neutral Density filter) 16 is also directly fixed to the supporting member 13. A driving lever 14 of the second driver 21 has one pin. This pin extends through the supporting member 13 to be projected to an opposite side face. The projected pin is fitted into a long groove of an ND filter supporting member 12 as a member for adjusting a quantity of light to operate the ND filter supporting member 12.

Note that, reference numeral 11 designates a partition plate which has both a function of pressing the ND filter supporting member 12 and a function of supporting the members 9 and 10 for adjusting a quantity of light, and reference numeral 8 designates a pressure plate which has a function of pressing the members 9 and 10 for adjusting a quantity of light.

Pins 2i and 2h projected from the driver supporting member 7 are fitted into long grooves of the members 9 and 10 for adjusting a quantity of light to operate the members 9 and 10 for adjusting a quantity of light, respectively. The members 9 and 10 for adjusting a quantity of light are operated in directions opposite to each other on the basis of rotation of the driving lever 2 to change an area of an opening portion 9a, 10a to thereby adjust a quantity of light passing through the opening portion. Note that, the member 9 for adjusting a quantity of light is provided with an ND filter 15.

The ND filter supporting member 12 is provided with the ND filter 16. The ND filter 16 is one sheet of filter of two concentrations. The ND filter supporting member 12 is operated separately from the members 9 and 10 for adjusting a quantity of light. That is to say, at the time when an area of the opening portion 9a, 10a defined by the members 9 and 10 for adjusting a quantity of light becomes a certain value, the members 9 and 10 for adjusting a quantity of light are made at a standstill to operate only the ND filter supporting member 12 to thereby allow a quantity of light to be adjusted with the ND filter 16.

According to the above-mentioned construction of this embodiment, there is solved a problem such that as in the prior art, a position of the axis of rotation is changed in a radial direction within the bearing portion, and hence the rotor magnet is not smoothly rotated so that a quantity of light is not properly adjusted.

In this embodiment, the cylindrical yoke 5 is mounted so that the yoke 5 surrounds the rotor magnet 3. Essentially, it is ideal that a distance (gap) between a rotor magnet and a yoke is uniform, and hence even when the rotor magnet is rotated, a direction of an applied magnetic force is not changed. In actuality, however, a shape of the yoke and a shape of the rotor magnet are not necessarily uniform, and hence, a distance between the rotor magnet and the yoke is changed depending on a rotation position.

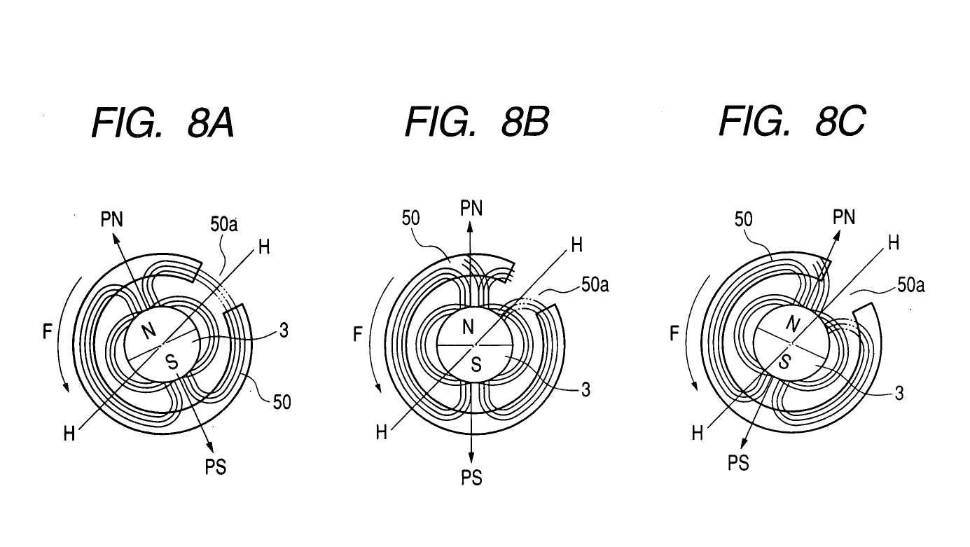

Next, a description will hereinbelow be given by giving as an example the device for adjusting a quantity of light in which when a current flow is cut off, the members for adjusting a quantity of light are held in a direction of blocking a light. FIG. 8A is a view showing a state of the rotor magnet 3 when the members 9 and 10 for adjusting a quantity of light overlap each other to make the opening disappear, FIG. 8C is a view showing a state of the rotor magnet 3 when the members 9 and 10 for adjusting a quantity of light are shifted from each other to form the largest opening portion, and FIG. 8B is a view showing a state of the rotor magnet 3 when the members 9 and 10 for adjusting a quantity of light are held in a middle state between the state shown in FIG. 8A and the state shown in FIG. 8C.

For the purpose of stably holding the rotor magnet without causing a current to flow through the coil, the magnetic balance of the driver is intentionally destroyed in some cases. As shown in FIGS. 8A to 8C, a cutout 50a is provided in a part of the yoke 50 to destroy the magnetic balance. In FIGS. 8A to 8C, the magnetic balance is destroyed so that the rotor magnet 3 is intended to be rotated towards a position where a magnetic flux flowing from the pole N to the pole S becomes maximum.

In FIG. 8A, the rotor magnet 3 is intended to be rotated towards a position where a prolongation of a boundary line between the pole N and the pole S of the rotor magnet 3 agrees with the center of the cutout of the yoke 50 (in FIGS. 8A to 8C, in a direction indicated by an arrow F). This position becomes a position where the rotor magnet 3 is most stably held. Of FIGS. 8A to 8C, in FIG. 8A in which the rotor magnet 3 is located in a position nearest the position where the rotor magnet 3 is most stably held, an attraction force PN acting between the pole N of the rotor magnet 3 and the yoke 50 becomes nearly equal in magnitude to an attraction force PS acting between the pole S of the rotor magnet 3 and the yoke 50 (strictly speaking, the attraction force PN is slightly smaller in magnitude than the attraction force PS since the pole N is nearer the cutout than the pole S).

As the rotor magnet 3 is rotated in a clockwise direction opposite to the direction indicated by the arrow F (FIG. 8A→FIG. 8B→FIG. 8C), the attraction force PN is further decreased, while the attraction force PS is further increased. Since the balance between these attraction forces is changed as the rotor magnet 3 is rotated, there is a possibility that a direction in which the rotor magnet 3 is attracted is changed. For example, when the pole N points to the direction of the gravity due to a position or the like, the rotor magnet 3 is attracted to the pole N side due to the gravity. Then, if the force of the pole S is increased along with the rotation, then the rotor magnet 3 is attracted to the pole S side in the middle of the rotation. In the case where as shown in FIGS. 6A and 6B, the front end portion of the axis portion has a spherical surface, and the bearing surface is planar, as a direction of an attraction force is changed, the axis is also freely moved so as to follow this change. In this connection, if the direction of the attraction force is slowly changed, then an influence exerted on a resultant image is relatively small. However, if the direction of the attraction force is abruptly changed, then a quantity of light passing through the opening portion is abruptly changed, which exerts an influence on the resultant image. This change is hardly generated when the weight of the axis and the rotor is very large, when a force of attracting the rotor to the bearing portion side (a biasing force in the direction indicated by the arrow r) is large, or when a contact resistance (friction) between the axis and the bearing surface is large.

However, since along with miniaturization, lightening, and power saving of the device for adjusting a quantity of light, the rotor magnet must be lightened and also the frictional resistance between the axis of rotation and the bearing portion must be made small, the above-mentioned change is easy to exert an influence on the resultant image. In the light of this respect, in this embodiment, as shown in FIGS. 1A and 1B, the first bearing portion 1a is formed in tapered recess shape (or hole-like shape) like a conical shape. As a result, even if the direction of the attraction between the yoke 5 and the rotor magnet 3 is changed, for the movement of the axis of rotation in the radial direction, the front end axis 2a must be forcibly made to go up the conical shaped slope of the first bearing portion 1a. Thus, the axis is prevented from being readily changed as in the conventional case where the bearing surface is planar. Moreover, since there is adopted the construction such that the magnetic biasing force acts in the direction r, the rotor magnet 3 is hardly moved in a radial direction all the more.

As described above, since the shape of the bearing portion adapted to rotatably receive the axis end portion of the axis of rotation is made the tapered recess shape (or the hole-like shape) such as the conical shape, it is possible to suppress the radial backlash of the axis of rotation. In addition, since there is provided the means for biasing one end portion of the axis of rotation to the bearing portion side, such a force acts on the axis of rotation as to press the axis of rotation towards the head portion having the tapered shape. Then, if the end portion of the axis of rotation is formed in a semi-spherical shape, then this end portion is pressed circumferentially when viewed from the axial direction. Thus, the positional change in the radial direction can be more effectively suppressed. As a result, the axis of rotation can be stably rotated even against a disturbance such as a magnetic fluctuation or a vibration. Moreover, an output signal of the Hall element 18, as a detector for detecting a position of a magnet, on which a change in distance between the Hall element and the rotor magnet 3 exerts a large influence is also stabilized to allow the stable control for a rotation position to be carried out.

Next, a second embodiment will hereinbelow be described.

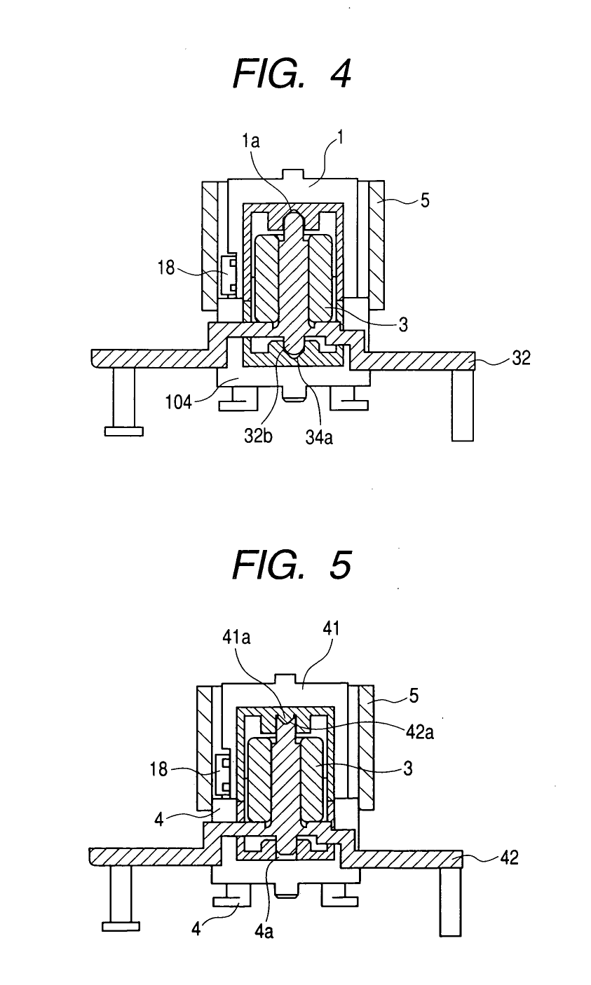

FIG. 4 is a cross sectional view of a driver used in a device for adjusting a quantity of light according to the second embodiment of the present invention. In the figure, the same constituent elements as those shown in FIGS. 1A and 1B are designated by the same reference numerals, and a description of the same constituent elements is omitted here for the sake of simplicity.

In the first embodiment, there is adopted the bearing construction such that the conical shaped recess portion is provided on the first case 1 side. However, in the second embodiment, as shown in FIG. 4, the similar bearing construction is adopted for a second case 34 side as well. That is to say, a second bearing portion 34a formed in conical shaped recess portion is provided in the second case 34, and also a rear end axis portion 32b of the axis of rotation of a driving lever 32 is formed in semi-spherical shape. Since other constituent elements are the same in construction as those of the first embodiment, a detailed description of other constituent elements is omitted here for the sake of simplicity.

In case of adopting such a construction, the driving lever 2 may be biased either to the first case 1 side or to the second case 34 side.

Next, a third embodiment will hereinbelow be described.

FIG. 5 is a cross sectional view of a driver used in a device for adjusting a quantity of light according to the third embodiment of the present invention. In the figure, the same constituent elements as those shown in FIGS. 1A and 1B are designated by the same reference numerals, and a description of the same constituent elements is omitted here for the sake of simplicity.

In the third embodiment of the present invention, there is shown an example in which a conical shaped recess portion is provided in a front end axis portion 42a of an axis of a driving lever 42, and also a first bearing portion 41a of a first case 41 is formed in semi-spherical (or spherical) projection shape. In this embodiment, a shape of the front end portion of the driving lever, and a shape of the bearing portion are only replaced with each other for the above-mentioned embodiment 1. Thus, since other constituent elements, operations, and the like of other constituent elements are the same as those in the above-mentioned embodiment 1, a detailed description of other constituent elements, operations, and the like of other constituent elements is omitted here for the sake of simplicity. Note that, it is to be understood that in the second embodiment, the shape of the front end portion of the driving lever and the shape of the bearing portion may be replaced with each other.

According to the above-mentioned embodiments, a position of the axis of rotation in a radial direction can be stably determined. As a result, it becomes possible to enhance the accuracy of the detection of a rotation position made using a Hall element or the like.

Further, since the first bearing portion and the second bearing portion are constructed using the different members (the first case and the second case), an assembly work can be readily carried out. Furthermore, since the bearing portions are respectively provided in the first case 1 and the second case 4 constituting the bobbin, it is possible to reduce the number of components or parts, and hence it is also possible to contribute to miniaturization and lightening of the device.

The present invention is not limited to the above embodiments and various changes and modifications can be made within the spirit and scope of the present invention. Therefore, to apprise the public of the scope of the present invention the following claims are made.

What is claimed is:

1. A driver, comprising:
a rotor adapted to be rotated with an axis portion as a center;
a first bearing for supporting one end of the axis portion of the rotor; and
a second bearing for supporting the other end of the axis portion of the rotor,
wherein a portion of the first bearing into which the axis portion is fitted has a tapered shape, and the axis portion is brought into contact with the portion having the tapered shape of the first bearing.

2. A driver according to claim 1, wherein the portion of the first bearing into which the axis portion is fitted has a conical shape.

3. A driver according to claim 1, wherein a portion of the axis portion which is fitted into the first bearing has one of a semi-spherical shape and a spherical shape.

4. A driver according to claim 1, wherein the portion of the first bearing into which the axis portion is fitted further has a shape for regulating a radial movement of the axis portion.

5. A driver according to claim 1, further comprising biasing means for axially biasing the axis portion of the rotor to bring the axis portion into contact with the first bearing.

6. A driver according to claim 5, further comprising a coil and a yoke, wherein a magnet is fixed to the rotor, the axis portion of the rotor is axially biased by a magnetic force acting between the yoke and the magnet, and a current is caused to flow through the coil to rotate the rotor.

7. A driver, comprising:
a rotor adapted to be rotated with an axis portion as a center;
a first bearing for supporting one end of the axis portion of the rotor; and
a second bearing for supporting the other end of the axis portion of the rotor,
wherein a portion of the axis portion which is fitted into the first bearing has a tapered shape, and the first bearing is brought into contact with the portion having the tapered shape of the axis portion.

8. A device for adjusting a quantity of light, comprising:
a rotor adapted to be rotated with an axis portion as a center;
a first bearing for supporting one end of the axis portion of the rotor;
a second bearing for supporting the other end of the axis portion of the rotor; and
a member for adjusting a quantity of light which moves in accordance with a rotation of the rotor,
wherein a portion of the first bearing into which the axis portion is fitted has a tapered shape, and the axis portion is brought into contact with the portion having the tapered shape of the first bearing.

9. A device for adjusting a quantity of light according to claim 8, wherein the portion of the first bearing into which the axis portion is fitted has a conical shape.

10. A device for adjusting a quantity of light according to claim 8, wherein a portion of the axis portion which is fitted into the first bearing has one of a semi-spherical shape and a spherical shape.

11. A device for adjusting a quantity of light according to claim 8, wherein the portion of the first bearing into which the axis portion is fitted further has a shape for regulating a radial movement of the axis portion.

12. A device for adjusting a quantity of light according to claim 8, further comprising biasing means for axially biasing the axis portion of the rotor to bring the axis portion into contact with the first bearing.

13. A device for adjusting a quantity of light according to claim 12, further comprising a coil and a yoke, wherein a magnet is fixed to the rotor, the axis portion of the rotor is axially biased by a magnetic force acting between the yoke and the magnet, and a current is caused to flow through the coil to rotate the rotor.

14. A device for adjusting a quantity of light according to claim 8, wherein the rotor is provided with a driving lever, and the driving lever is fitted into the member for adjusting a quantity of light.

15. A device for adjusting a quantity of light according to claim 13, wherein the first bearing is provided in a first case, the second bearing is provided in a second case, the first case and the second case constitute a bobbin, and the coil is wound around the bobbin.

16. A device for adjusting a quantity of light according to claim 9, wherein the conical shape is formed so as for an angle of its vertex to fall within the range of 90 to 110 degrees.

17. A device for adjusting a quantity of light according to claim 8, wherein a position of the rotor is detected by a Hall element.

18. A device for adjusting a quantity of light, comprising:
a rotor adapted to be rotated with an axis portion as a center;
a first bearing for supporting one end of the axis portion of the rotor;
a second bearing for supporting the other end of the axis portion of the rotor; and
a member for adjusting a quantity of light which moves in accordance with a rotation of the rotor,
wherein a portion of the axis portion which is fitted into the first bearing has a tapered shape, and the first bearing is brought into contact with the portion having the tapered shape of the axis portion.
